(19) United States
(12) Patent Application Publication
(10) Pub. No.: US 2003/0015332 A1
(43) Pub. Date: Jan. 23, 2003

(54) Floor covering with wiring

(76) Inventors: Arriz Hassam, Toronto (CA); John Anthony Tong, Toronto (CA); Paul Denness John Syme, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 09/804,150

(22) Filed: Mar. 13, 2001

Related U.S. Application Data
(60) Provisional application No. 60/189,059, filed on Mar. 14, 2000.

(51) Int. Cl. H02G 3/04

(52) U.S. Cl. 174/48

(57) ABSTRACT

A floor covering which incorporates wiring for providing electrical power and/or communication services to at least one location on the floor covering, means for connecting the wiring externally of the covering to a source of electrical power and/or to an external communication service, and connection means at said location for permitting connection to the wiring of a device requiring said source of electrical power and/or communication service.

### CROSS-REFERENCE TO RELATED APPLICATIONS

This application claims benefit from U.S. provisional application Serial No. 60/189,059 filed Mar. 14, 2000 which is incorporated herein by reference in its entirety.

### FIELD OF THE INVENTION

This invention relates generally to the provision of electrical power and/or communication services to a work area, for example, in an office.

### BACKGROUND OF THE INVENTION

Traditionally, electrical power and communications wiring (e.g. telephone wiring) has been routed to specific work areas through walls or ceilings in a building. In a private office, for example, the wiring may simply be connected to standard receptacles and jacks in a wall adjacent to a desk, so that electrical devices, telephones, etc. on the desk can be plugged in. In a larger office, such as an open plan office having a number of different work areas, the wiring can be routed to individual work areas in a number of ways. There can be a main feed conduit containing electrical and communications wiring that is connected to a particular desk, and from which wiring is routed to other desks in the work area, through the desks themselves, or through partitions or other conduits linking the individual desks.

Wiring can also be routed down from a ceiling space, through hollow posts or columns to individual desks, or to a group of interconnected desks.

Examples of U.S. patents considered in the preparation of this application are U.S. Pat. Nos. 4,578,731, 4,728,300 and 4,746,308.

### SUMMARY OF THE INVENTION

An object of the present invention is to provide a novel method of delivering electrical power and/or communication services to a work area.

According to the invention there is provided a floor covering which incorporates wiring for providing electrical power and/or communication services to at least one location on the floor covering. In more detail, the floor covering comprises a substrate for extending over a floor area and providing a traffic surface of the covering, and the wiring is carried by the substrate. External means is provided for connecting the wiring to a source of electrical power and/or to an external communication service, and connection means is provided at the said location and is accessible from the traffic surface for permitting connection to the wiring of a device requiring the said source of electrical power and/or communication service.

In summary, the invention provides power and/or communication services to a workspace by routing associated wiring through the floor covering itself to a connection point within the area of the floor covering. A computer, telephone or other device, for example, on a desk disposed on the floor covering, can then simply be connected (plugged in) at the relevant location or locations on the floor covering.

Preferably, the covering incorporates wiring for both electrical and communications services. It is also preferred that, for each service, there be an array of connection points distributed appropriately over the traffic surface of the floor covering so as to provide a choice of locations at which to plug in. A desk can then be positioned wherever is appropriate on the floor covering, and electrical and/or communications devices can be plugged in to a convenient location.

The connection points may comprise conventional telephone jacks for communications services (including computer network jacks) and electrical receptacles for electrical power. Telephone jacks that are not being used can simply be covered by a suitable cap. An electrical receptacle may be incorporated in a separate monument or fixture that is installed only at a particular location at which it has been determined that power is required. Unused locations can comprise a monument base within the floor covering that is covered by a removable cap, and to which a monument can be fitted. There is then no obstruction of the covering surface by a receptacle that is not being used.

Typically, the floor covering will be in the nature of an area rug or mat that is designed to be placed wherever appropriate in a workspace without covering the whole of the floor. On the other hand, it is still within the scope of the invention that the covering could be shaped to cover the entire floor area. When the covering is in the form of a rug or mat, it may be of any appropriate shape, not necessarily regular. The size will of course depend on the work area and the number of desks or other work stations to be accommodated on the covering.

The covering itself may comprise a one-piece substrate with wiring embedded within the substrate. Preferably, however, the substrate is a laminated structure comprising an underlay carrying wiring, an insulating layer that incorporates connection points for electrical power and communication services, and a traffic layer on top through which the connection points can be accessed.

### BRIEF DESCRIPTION OF DRAWINGS

In order that the invention may be more clearly understood, reference will now be made to the accompanying drawings which illustrate a particular preferred embodiment of the invention by way of example, and in which:

FIG. 1 is a perspective view of a floor covering in accordance with the invention, with two desks shown disposed on the floor covering;

FIG. 2 is a view similar to FIG. 1 but without the desks, and showing elements of the covering in exploded positions;

FIG. 3 is a perspective view showing three layers of the floor covering in exploded positions;

FIG. 4 is a fragmentary perspective view of one corner of the assembled floor covering;

FIG. 5 is a sectional view on line V V of FIG. 4;

FIG. 6 is a partially exploded perspective view of a base component for an electrical receptacle monument of the covering; and,

FIGS. 7 and 8 are side elevational and underneath perspective views respectively of the monument itself.

### DESCRIPTION OF PREFERRED EMBODIMENT

Referring first to FIG. 1, a floor covering in accordance with the invention is generally denoted by reference numeral 20 and comprises a substrate 22 that provides a traffic surface 23 of the covering. Two desks 24 are shown on the traffic surface. Each desk supports a computer represented diagrammatically at 26 that requires both electrical power and connection to a telecommunication service. Of course, the computer is a representative example only of many types of different devices that can be accommodated, including telephones.

As will be described in detail later, the floor covering 20 incorporates wiring for providing both electrical power and communication services to a plurality of locations distributed over the surface 22 of the floor covering. Locations for receiving electrical power are represented by circles denoted 28, while locations for telecommunication service connections are represented by cruciform elements 30.

A conduit enclosing cables for connecting the internal wiring to a source of electrical power and to external telecommunication services is represented generally at 32.

FIG. 2 shows the floor covering 20 without the desks 24 and computers 26. It will be seen that the locations 28 and 30 for power and telecommunication services respectively are distributed fairly widely over the area of the surface 22 of the floor covering and are arranged in pairs, i.e. with a telecommunications location adjacent each power location.

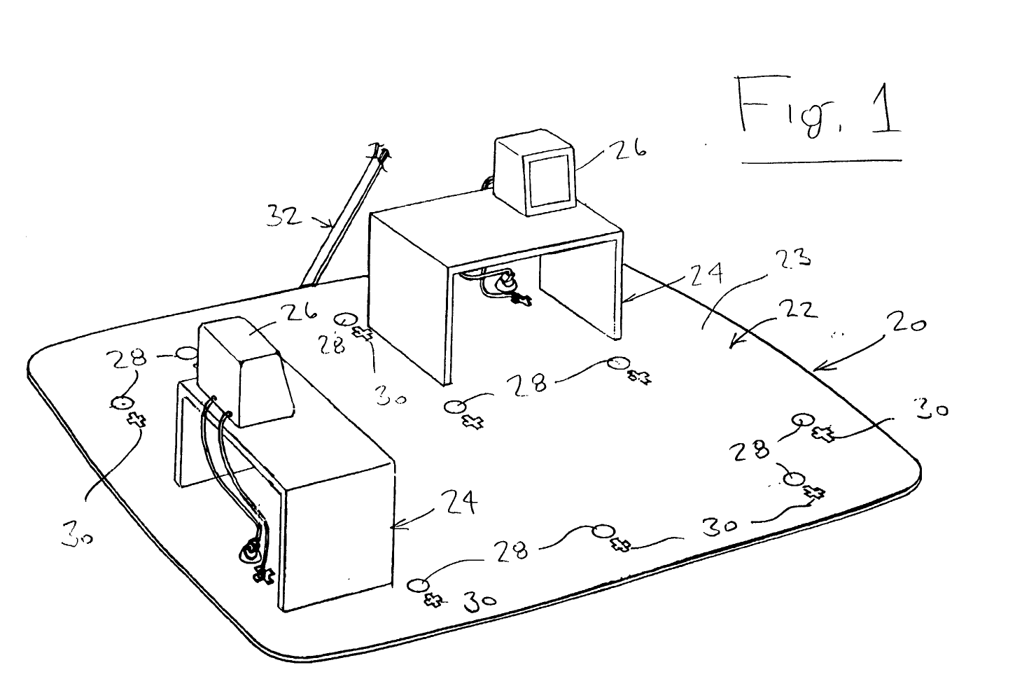

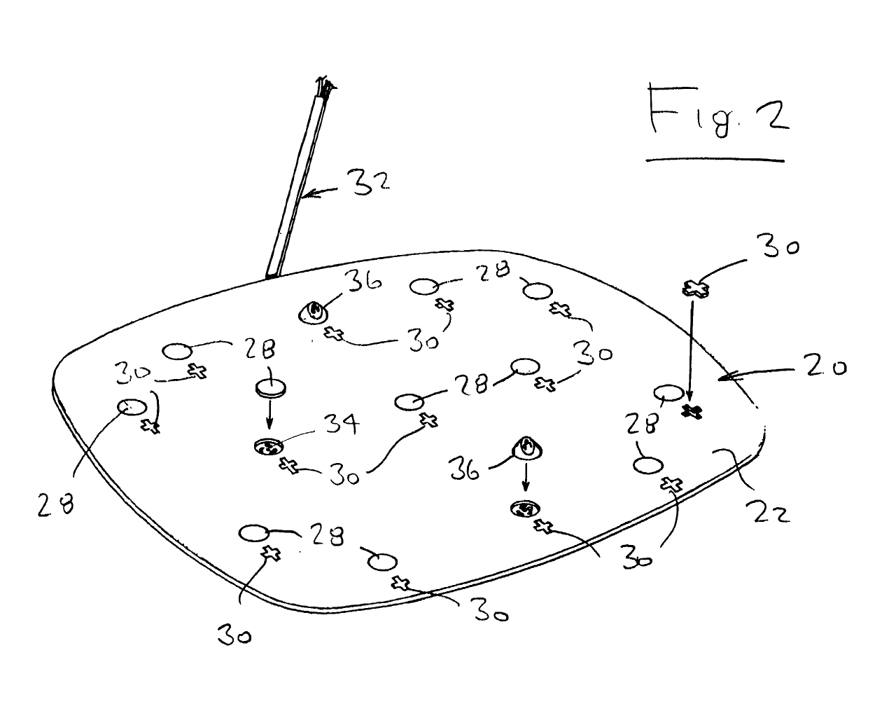

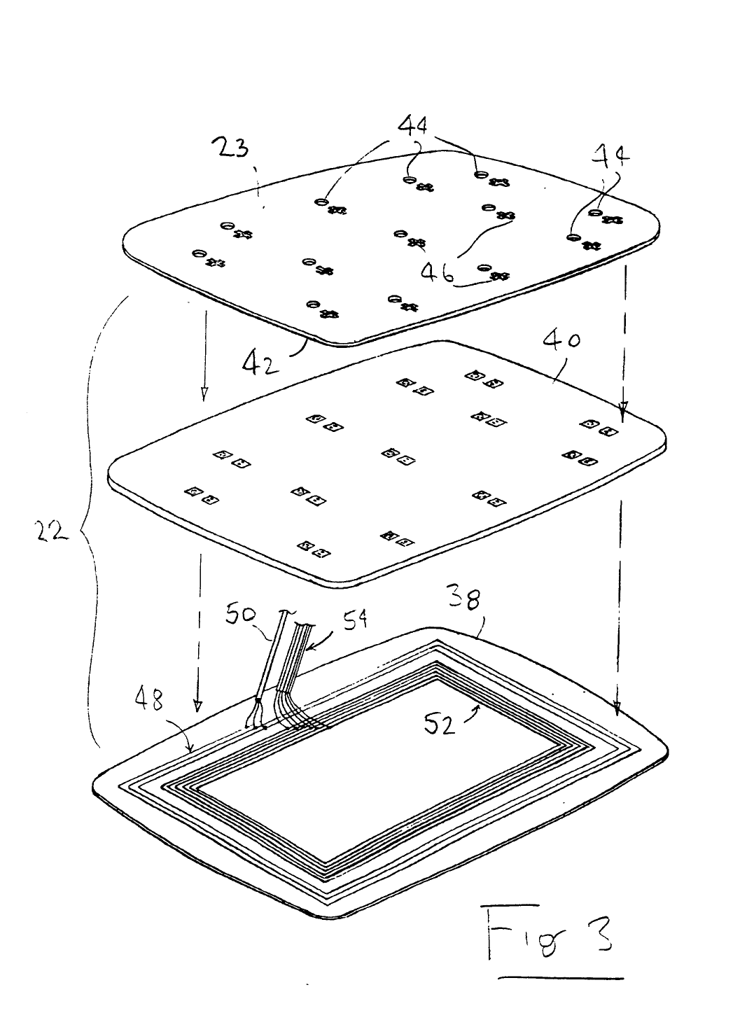

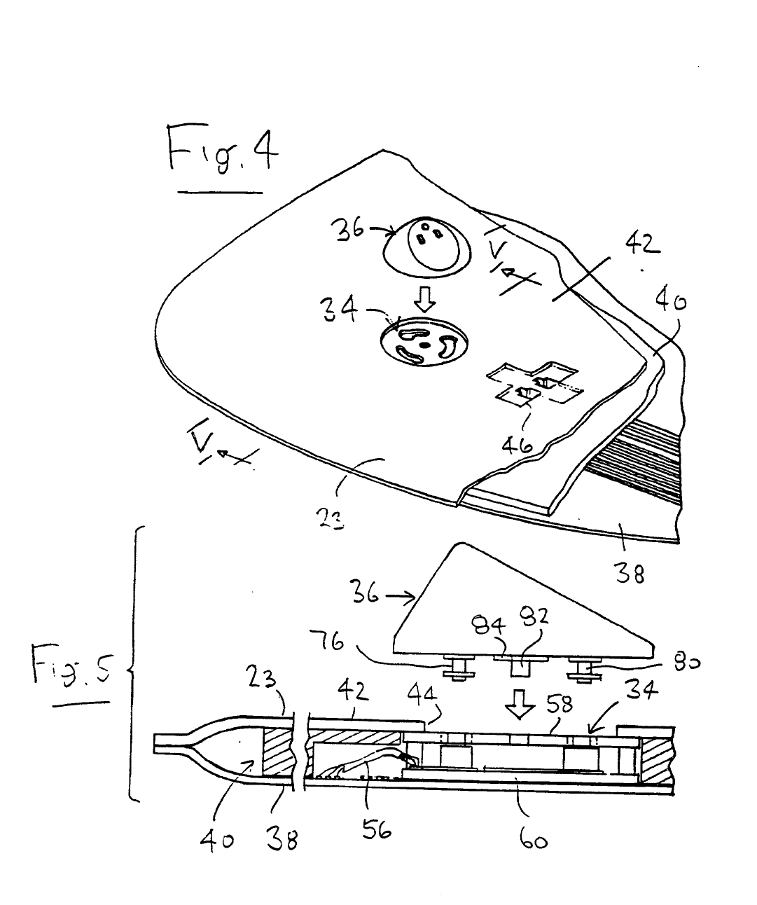

The circles representing the power locations are in fact circular caps that fit into corresponding openings in the surface 22 of the covering, and each of which conceals a base 34 to which a receptacle monument 36 can be coupled when a particular location is to be used. FIGS. 4 to 8 show the bases and monuments in more detail.

Each of the cruciform elements 30 is a simple cover that conceals a pair of conventional jacks for voice and data communication. The covers 28 and 30 are simply push-fitted into corresponding openings in the top of the floor covering and can readily be pried up to give access to the connections below. Conversely, when the covers are in place, they maintain the continuity of the top surface of the floor covering.

FIG. 3 shows that the floor covering in fact has a laminated substrate 22 comprising an underlay 38, and insulating layer 40 and a traffic layer 42. While there is no limitation to particular materials, the underlay 38 may comprise a rubber cushioning layer and a plastic sheet (e.g. vinyl) carrying wiring, the insulating layer may be rubber, possibly with a styrene protective sheet, while the traffic layer may be a section of commercially available floor covering material such as a carpet that is available under the trade mark FLOTEX or TAPISOM.

The traffic layer has openings 44 and 46 to accommodate the electrical power location covers 28 and the covers 30 for the communications jacks. Layer 40 acts as a carrier for the communications jacks and bases 34 for the electrical power connections (to be described), while underlay 38 carries the electrical wiring. The three layers may be glued or otherwise secured together so that the wiring is protected.

Again, there is no limitation to the particular configuration of wiring shown in the drawings. However, by way of example, the wiring may comprise an outer loop 48 of three tracks comprising respectively live, neutral and ground, to which corresponding power supply leads 50 of the supply conduit 32 are coupled. Inwardly of loop 48 are additional loops 52 of communication wiring to which individual telecommunication lines 54 are coupled. Each of the telecommunication jacks in the floor covering may have its own line. The electrical monument bases 34 on the other hand will be series connected to the tracks of loop 48.

In the illustrated embodiment, the wiring loops 48 and 52 are printed circuit tracks on the top surface of the underlay 38. It is, however, to be understood that other forms of wiring could alternatively be used, e.g. individual flexible wires secured at intervals to the underlay 38. Also, the wiring need not be configured in loops as shown.

Referring now to FIGS. 4 and 5, a monument for providing an electrical receptacle on the floor covering is shown at 36 in an exploded position above the traffic surface 23 of the floor covering 20. A base 34 is visible within an opening 44 in the traffic layer 42 of the covering. The base 34 is disposed on the underlay 38 and below the traffic layer 42, in a space defined by the insulating layer 40. The receptacle is hard-wired to the outer wiring loop 48 by wiring indicated at 56.

Reverting to FIG. 3, it can be seen that the wiring extends around a relatively large unobstructed central area of the underlay. Preferably, the receptacle bases 34 are disposed in this area.

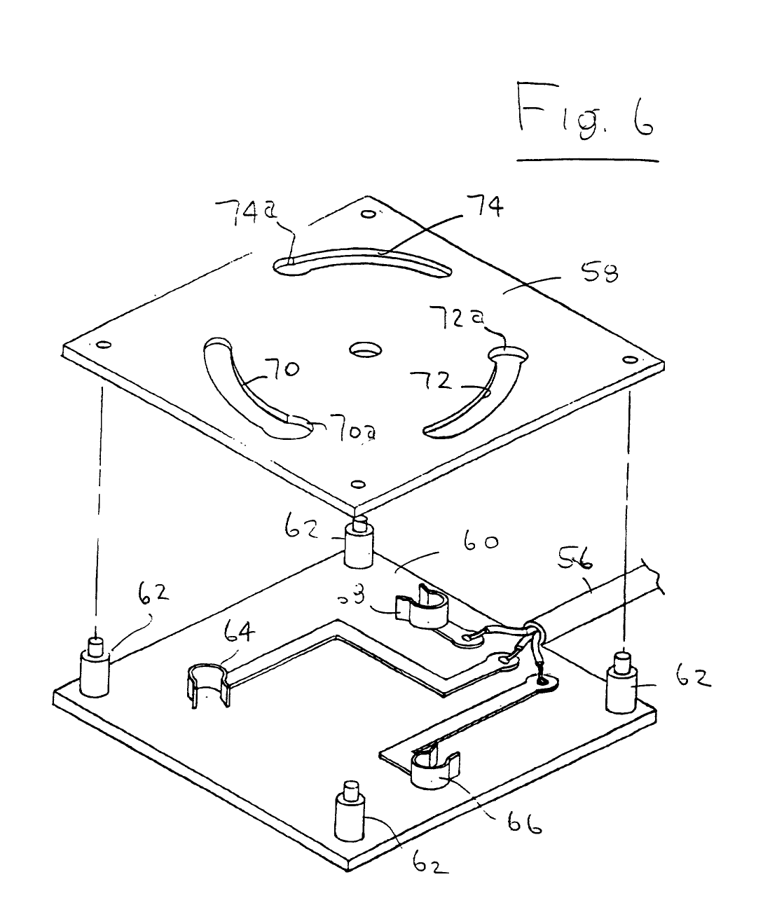

FIG. 6 shows one of the receptacle bases 34 and illustrates the fact that the base comprises upper and lower plates 58 and 60 respectively that are supported in spaced parallel positions by corner posts 62 extending between the plates. In FIG. 6, the top plate 58 is shown exploded above the bottom plate 60 to reveal electrical terminal clips 64, 66 and 68 that are coupled to the wiring 56 shown in FIG. 5. It can be seen that the clips 64, 66 and 68 each have a C-shape configuration as seen from above. The clips line up with respective arcuate slots 70, 72 and 74 in the top plate 58. Each slot has an enlarged portion 70a, 72a, 74a at one end and the clips are aligned with the opposite (inner) ends of the respective slots.

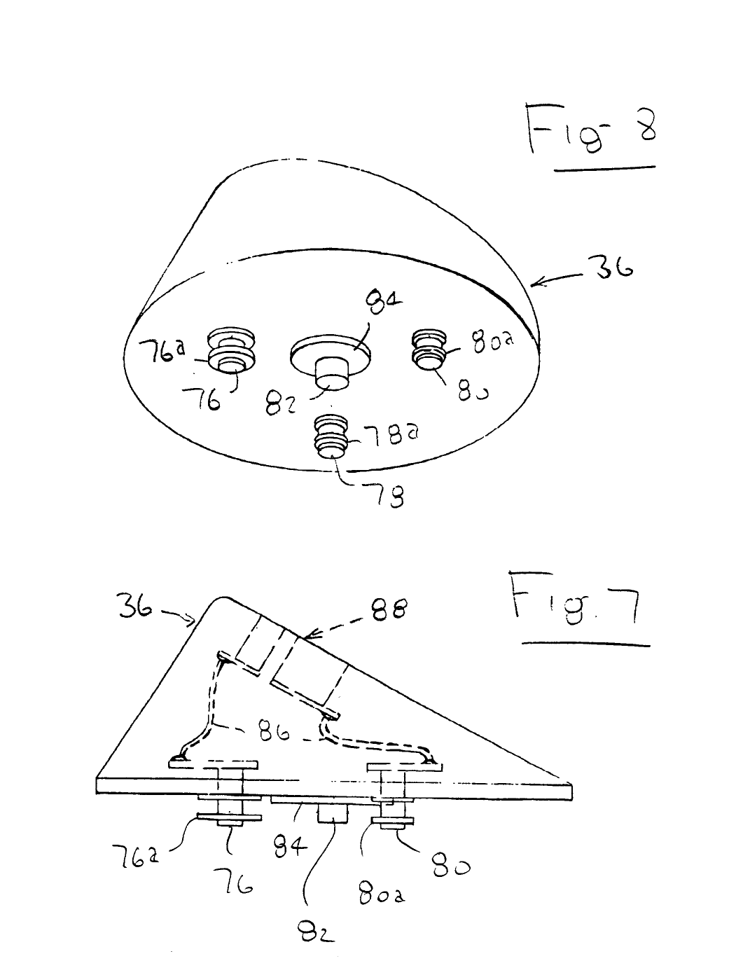

Referring now to FIGS. 7 and 8, it will be seen that the receptacle monument 36 has a generally wedge-shaped configuration as seen from the side and a flat bottom surface from which depend three pins 76, 78 and 80 that correspond with the respective slots 70, 72 and 74 and clips 64, 66 and 68. The pins have enlarged flanges 76a, 78a and 80a that are dimensioned to fit relatively closely through the enlarged opening 70a, 72a and 74a of the respective slots when the monument is appropriately positioned on the base and depressed. The monument 36 can then be turned counter-clockwise as seen in FIG. 6 with the flanges 76a, 78a and 80a below the plate 58, to bring the pins 76, 78 and 80 to the inner ends of the slots and into engagement with the respective clips 64, 66 and 68. Flange 76a and the corresponding opening 70a are larger than the other two flanges and openings so that the monument can be fitted to its base in one angular position only.

At the centre of the bottom face of the monument is a plain pin 82 which is fitted with a resilient washer 84. When the monument 36 is fitted to the base 34 and the monument is depressed, the washer 84 is compressed. When the monument is in its fully installed position on the base 34, the washer 84 returns somewhat to its original thickness, so that the monument is held snugly in place on the base.

In the installed position of the monument, the pins 76, 78, and 80 engage in the respective clips 64, 66 and 68 and provide electrical connections to the wiring 56. As seen in FIG. 7, internally, the monument has wiring 86 that connects the pins 76, 78 and 80 to a conventional electrical receptacle 88 within the monument.

In summary, the floor covering of the invention allows provision of electrical and communication services to work areas without the need for lengthy cables extending across the floor surface, power poles or columns extending up to the ceiling, or expensive inter-connection of desks. An array of connection points can be provided across the surface of the covering so that a point is convenient for almost any desk or other work station location. Unused connection points are covered so that the integrity of the floor surface is not compromised.

It should of course be appreciated that the preceding description relates to a particular preferred embodiment of the invention only and that many modifications are possible, some of which have been indicated previously and others of which will be apparent to a person skilled in the art.

1. A floor covering comprising a substrate for extending over a floor area and providing a traffic surface of the covering; wiring carried by the substrate for providing electrical power and/or communication services to at least one location on the traffic surface; external means for connecting the wiring to a source of electrical power and/or to an external communication service; and connection means at said location accessible at said traffic surface for permitting connection to the wiring of a device requiring said source of electrical power and/or communication service.

2. A floor covering as claimed in claim 1, wherein said wiring comprises electrical wiring and communication service wiring, said wiring providing electrical power and communication services to a plurality of said locations distributed over the traffic surface of the floor covering.

3. A floor covering as claimed in claim 2, wherein each said location comprises paired said connection means for providing both electrical power and communication service connections at each said location.

4. A floor covering as claimed in claim 2, wherein said connection means for communication services comprises at least one telephone jack at each said location accessible from said traffic surface, and wherein said connection means for electrical wiring comprises, at each location, a base within said substrate of the floor covering connected to said electrical wiring, a cap adapted to be removably coupled to the base when the connection means is not in use, and a monument adapted to be removably coupled to the base when electrical power is required at said location, the monument including an electrical receptacle accessible from externally of the monument, and means engagable with the base for electrically connecting the receptacle to the wiring through the base when the monument is in position on the base.

5. A flooring covering as claimed in claim 4, wherein each said monument includes an upper surface providing openings communicating with said electrical receptacle, and a lower surface provided with live, neutral and ground pins that are adapted to releasably engage the base, the base being provided with electrical contacts connected to said wiring for contacting the pins when the monument is installed on the base for electrically connecting the receptacle to the wiring.

6. A floor covering as claimed in claim 5, wherein the said substrate has a laminated structure comprising an underlay, an insulating layer on the underlay, and a traffic layer on the insulating layer, the traffic layer providing the traffic surface of the floor covering, and wherein the wiring is provided on an upper surface of the underlay, the insulating layer carries telephone jacks coupled with communication wiring on the underlay and bases of said electrical monuments coupled with electrical wiring on the underlay, and wherein the traffic layer has openings providing access to said telephone jacks and monument bases.

7. A floor covering as claimed in claim 6, wherein said wiring comprises printed circuit tracks on said upper surface of the underlay.
